(19) United States
(12) Patent Application Publication
(10) Pub. No.: US 2017/0193609 A1
(43) Pub. Date: Jul. 6, 2017

(54) SYSTEM AND METHOD FOR AUTOMATICALLY MONITORING REQUESTS INDICATED IN ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/416,563

(22) Filed: Jan. 26, 2017

Related U.S. Application Data
(63) Continuation-in-part of application No. 15/361,934, filed on Nov. 28, 2016.
(60) Provisional application No. 62/337,890, filed on May 18, 2016.
(60) Provisional application No. 62/260,553, filed on Nov. 29, 2015.
(60) Provisional application No. 62/261,355, filed on Dec. 1, 2015.

(51) Int. Cl. G06Q 40/00; G06K 9/00; G06K 9/18

(52) U.S. Cl. CPC G06Q 40/123; G06K 9/18; G06K 9/00463

(57) ABSTRACT

A system and method for automatically monitoring a request indicated in an electronic document. The method includes analyzing the electronic document to determine at least one request parameter, wherein the electronic document includes at least partially unstructured data; creating, based on the analysis of the electronic document, a request template for the electronic document, wherein the request template is a structured dataset including the determined at least one request parameter; setting, based on the created request template, a timer, wherein the timer is set at least with respect to a time of submission of the request; and upon expiration of the timer, determining, based on the created request template, a status of the request.

### CROSS-REFERENCE TO RELATED APPLICATIONS

This application claims the benefit of U.S. Provisional Application No. 62/337,890 filed on May 18, 2016, now pending. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to monitoring statuses of requests submitted via electronic documents, and more particularly to monitoring statuses of requests based on contents of electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Typically, to reclaim VATs paid during a transaction, evidence in the form of documentation indicating information related to the transaction (such as an invoice or receipt) as well as request documentation (e.g., a reclaim form) must be submitted to an appropriate refund authority (e.g., a tax agency of the country refunding the VAT). If the information in the submitted evidentiary documentation does not match the information submitted in the reclaim documentation, the request is denied and no reclaim is granted.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

Additionally, once a VAT reclaim request is submitted, the request may not result in successful reclaiming of taxes paid. The failure to obtain a reclaim may be due to, for example, the request being denied, the request not being received by an appropriate tax authority, and the like. If a reclaim has not been successfully obtained, an entity may wish to provide additional information needed to successfully obtain the reclaim. Existing solutions for confirming that a reclaim has been successfully obtained typically include manual checking by, e.g., noting each reclaim request and sending a status request for each reclaim request to the appropriate tax authorities. Such manual checking therefore requires additional recordkeeping and is subject to human error.

Moreover, as organizations increasingly keep electronic records of expenses and other events to be reported, the amount of data needing to be processed has increased astronomically. Specifically, many such events are memorialized in electronic documents such as, for example, scans (e.g., of invoices or receipts), text-based expense reports completed by employees, and the like. The sheer volume of such electronic documents results in a total amount of data that is not suitable for manual review. Although some solutions exist for automatically analyzing electronic documents, such solutions face challenges in accurately recognizing and utilizing data contained in the electronic documents, particularly when the data in the electronic documents does not follow a known structure. As a result, such solutions are not suitable for use with common forms of data input such as scans of completed reporting forms.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for automatically monitoring a request indicated in an electronic document. The method comprises: analyzing the electronic document to determine at least one request parameter, wherein the electronic document includes at least partially unstructured data; creating, based on the analysis of the electronic document, a request template for the electronic document, wherein the request template is a structured dataset including the determined at least one request parameter; setting, based on the created request template, a timer, wherein the timer is set at least with respect to a time of submission of the request; and upon expiration of the timer, determining, based on the created request template, a status of the request.

Certain embodiments disclosed herein also include a non-transitory computer readable medium having stored thereon instructions for causing a processing circuitry to perform a process, the process comprising: analyzing the electronic document to determine at least one request parameter, wherein the electronic document includes at least partially unstructured data; creating, based on the analysis of the electronic document, a request template for the electronic document, wherein the request template is a structured dataset including the determined at least one request parameter; setting, based on the created request template, a timer, wherein the timer is set at least with respect to a time of submission of the request; and upon expiration of the timer, determining, based on the created request template, a status of the request.

Certain embodiments disclosed herein also include a system for automatically monitoring a request indicated in an electronic document. The system comprises: a processing circuitry; and a memory, the memory containing instructions that, when executed by the processing circuitry, configured the system to: analyze the electronic document to determine at least one request parameter, wherein the electronic document includes at least partially unstructured data; create, based on the analysis of the electronic document, a request template for the electronic document, wherein the request template is a structured dataset including the determined at least one request parameter; set, based on the created request template, a timer, wherein the timer is set at least with respect to a time of submission of the request; and upon expiration of the timer, determine, based on the created request template, a status of the request.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for automatically monitoring a request indicated in an electronic document according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automatically monitoring a request indicated in an electronic document. In an embodiment, a dataset is created based on an electronic document indicating information related to a request. The request may be for a reclaim of value-added taxes (VATs) paid during a transaction. A request template of transaction attributes is created based on the created dataset.

Based on the created request template, a value for a timer is determined and the timer is set using the determined timer value. The timer value may be based on a period of time beginning with the time of submission of the request indicated in the electronic document. When the timer expires (e.g., when a countdown reaches zero, when a particular date or time, it is determined whether the request was granted. The determination may include determining, based on the created request template, a status of the request. If the request was not granted, at least one cause of the lack of granting may be determined. A notification indicating the status of the request may be generated. When the request is not granted, the notification may further include the determined at least one cause of the lack of granting.

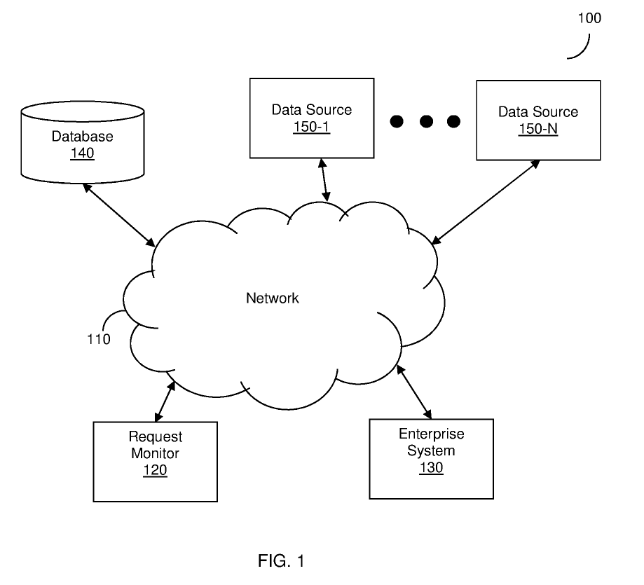

FIG. 1 shows an example network diagram 100 utilized to describe the various disclosed embodiments. In the example network diagram 100, a request monitor 120, an enterprise system 130, a database 140, and a plurality of data sources 150-1 through 150-N (hereinafter referred to individually as a data source 150 and collectively as data sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise system 130 further stores data related to requests (e.g., requests for VAT reclaims) to be submitted by the enterprise (e.g., an image file showing a VAT reclaim request form submitted by an employee of the enterprise). The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a completed VAT reclaim request form, a scan of an invoice, a text file, a spreadsheet file, etc.). Each electronic document may show, e.g., an invoice, a tax receipt, a purchase number record, a VAT reclaim request, and the like. Data included in each electronic document may be structured, semi-structured, unstructured, or a combination thereof. The structured or semi-structured data may be in a format that is not recognized by the request monitor 120 and, therefore, may be treated as unstructured data.

The database 140 may store data related to statuses of pending requests. Such data may include, e.g., statuses of requests determined or obtained by the request monitor 120, causes of lack of granting of requests, or both.

The data sources 150 store at least information related to the status of pending or processed requests. The data sources 150 may include, but are not limited to, tax authority servers. As a non-limiting example, the data source 150-1 may be a server of an Israel tax authority, and the data source 150-8 may be a server of a Scotland tax authority.

In an embodiment, the request monitor 120 is configured to create a request template based on request parameters identified using machine vision of an electronic document indicating information related to a VAT reclaim request with respect to a transaction. In a further embodiment, the request monitor 120 may be configured to retrieve the electronic document from, e.g., the enterprise system 130. Based on the created request template, the request verifier 120 is configured to at least determine a status of the request.

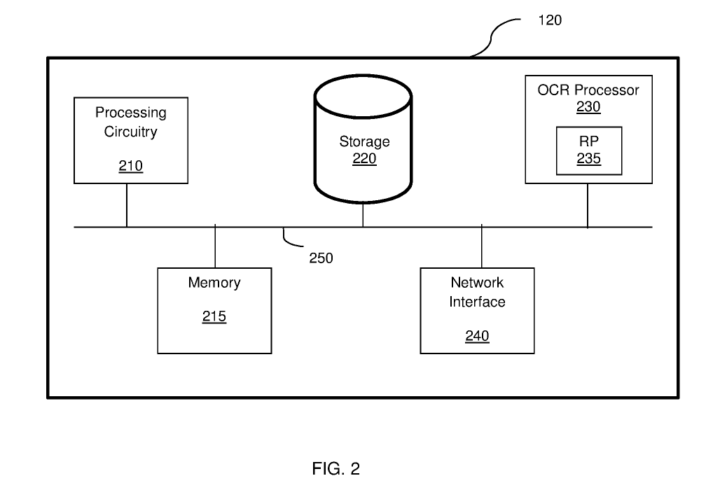

In an embodiment, the request monitor 120 is configured to create datasets based on electronic documents including data at least partially lacking a known structure (e.g., unstructured data, semi-structured data, or structured data having an unknown structure). To this end, the request monitor 120 may be further configured to utilize optical character recognition (OCR) or other image processing to determine data in the electronic document. The request monitor 120 may therefore include or be communicatively connected to a recognition processor (e.g., the recognition processor 235, FIG. 2).

In an embodiment, the request monitor 120 is configured to analyze the created datasets to identify request parameters related to the request indicated in the electronic documents. The request parameters may include, but are not limited to, parameters related to the submission of the request (e.g., a date of submission, an entity submitting the request, and entity to receive the request, etc.), parameters related to a transaction related to the request (e.g., transaction parameters such as buyer, seller, price, quantity, types of products, date of transaction, transaction identification number, etc.), or both. In an embodiment, the request monitor 120 is configured to create request templates based on the created datasets. Each request template is a structured dataset including the identified request parameters for a transaction.

In an embodiment, the request monitor 120 is configured to create a request template based on the electronic document. The request template may be, but is not limited to, a data structure including a plurality of fields. The fields may be predefined, and may include the identified request parameters. Based on the created request template, the request monitor 120 is configured to set a timer. Setting the timer may include, but is not limited to, determining a value for the timer based on the created request template. In a further embodiment, the request monitor 120 may be configured to query one of the data sources 150 for an estimated time of processing for the request. Thus, in an embodiment, the timer may be set to expire based on a date of the transaction for which the request was made (e.g., the date of a purchase for which a VAT reclaim is sought) and an estimated time of processing.

In an embodiment, when the timer expires, the request monitor 120 is configured to check a status of the request to determine if the request has been granted. In a further embodiment, the request monitor 120 may be configured to query one of the data sources 150 for the status of the request. The status of the request may indicate, e.g., that the request was granted, that the request was declined, that the request was not received, that the request has been received but has not yet been processed, and the like.

In an embodiment, when it is determined that the request has not been granted, a cause of the lack of granting the request may be determined. A request may not be granted if, e.g., the request form was incomplete, the request form was not received by an appropriate request processing authority (e.g., a particular tax agency), the request did not meet one or more request granting requirements (e.g., for a VAT reclaim request, the request may only be granted if the buyer has a different country of residence or incorporation than the seller), information in the request did not match information indicated by documents evidencing the request, and the like. A lack of granting of the request may be associated with statuses indicating, but not limited to, that the request has been denied, that the request has not been received, that the request has been received but has not yet been processed, and the like.

Potential causes of failure to grant a request may include circumstances or assumptions related to the cause of the non-granted request. The potential causes may be determined based on one or more causation rules. In an embodiment, the causation rules may include potential causes associated with missing or incomplete information, whether the electronic document including the request is in the possession of an appropriate request processing authority, a difference between information in the request and request granting requirements, a difference between information in the request and information in an electronic document evidencing the request, and the like.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the request monitor 120 according to an embodiment. The request monitor 120 includes a processing circuitry 210 coupled to a memory 215, a storage 220, and a network interface 240. In an embodiment, the data integrity manager 120 may include an optical character recognition (OCR) processor 230. In another embodiment, the components of the request verifier 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to perform automatic monitoring of requests indicated in electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the data integrity manager 120 to communicate with the enterprise system 130, the database 140, the web sources 150, or a combination of, for the purpose of, for example, collecting metadata, retrieving data, storing data, and the like.

It should be understood that the embodiments described herein are not limited to the specific architecture illustrated in FIG. 2, and other architectures may be equally used without departing from the scope of the disclosed embodiments.

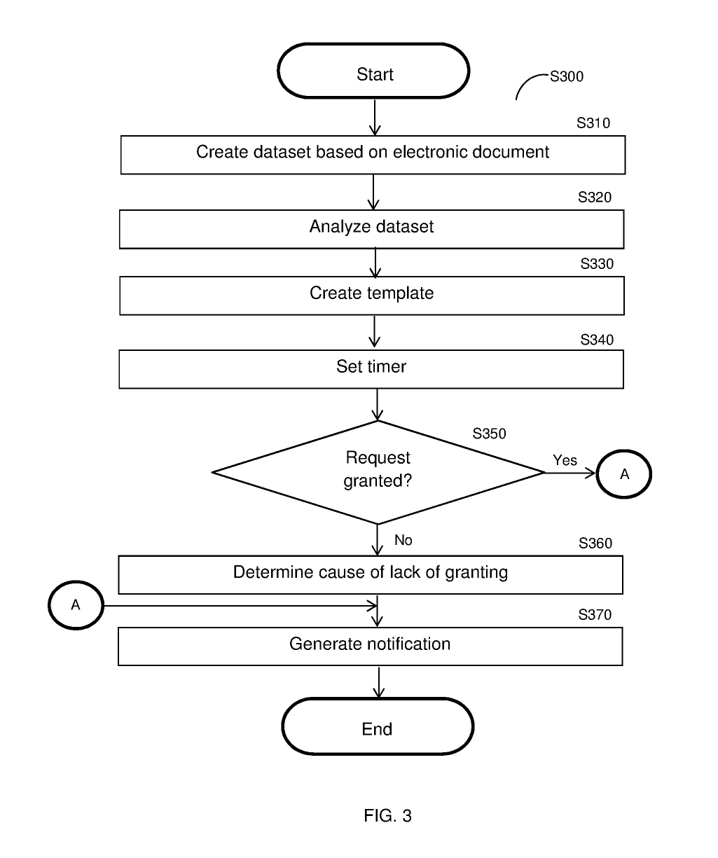

FIG. 3 is an example flowchart 300 illustrating a method for automatically monitoring a request indicated in an electronic document according to an embodiment. In an embodiment, the method may be performed by a request verifier (e.g., the request verifier 120).

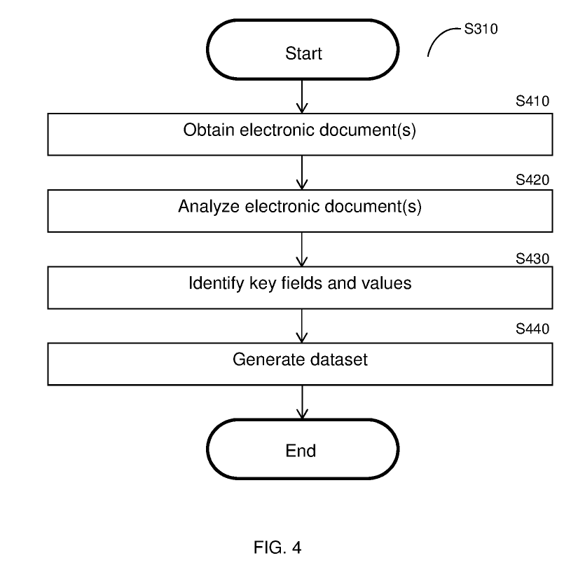

At S310, a dataset is created based on an electronic document including information of a request related to a transaction. The electronic document may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

At S320, the created dataset is analyzed. In an embodiment, analyzing the created dataset may include, but is not limited to, determining request parameters such as, but not limited to, a date of submission of the request, at least one entity identifier (e.g., a consumer enterprise identifier, a merchant enterprise identifier, or both), information related to the transaction that the request is based on (e.g., a date, a time, a price, a type of good or service sold, etc.), or a combination thereof.

At S330, a request template is created based on the dataset. The request template may be, but is not limited to, a data structure including a plurality of fields. The fields may include the identified request parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, a value for a timer is determined based on the created request template. The timer may be utilized to indicate when a status of the request should be checked. As a non-limiting example, the timer may be set to expire after 30 days have passed since submission of the request. In an embodiment, the timer value may be determined based on, but not limited to, a time of submission of the request, a request processing authority to which the request is sent (i.e., different request processing authorities may have different average wait periods for granting requests depending upon, e.g., staffing, number of requests in a queue, etc.), a seller indicated in the request (i.e., a request related to a transaction involving a newly registered seller may take longer to process than a request related to a transaction involving a longtime registered seller), combinations thereof, and the like.

In an embodiment, the timer value may be determined based on at least one timer setting rule. Alternatively or collectively, S340 may include querying, in real-time, a data source associated with the request processing authority to which the request was sent based on information in the created request template (e.g., a request identifier, a transaction identifier, etc.). Querying the data source in real-time may allow for more accurate values for the timer based on current information related to time for processing requests (e.g., a current number of requests in a queue may be utilized to more accurately determine an expected time for processing a newly received request).

At S350, when the timer has expired, it is determined whether the request was granted and, if so, execution continues with S370, otherwise, execution continues with S360. In an embodiment, S350 includes determining a status of the request. In a further embodiment, S350 may include querying at least one data source (e.g., a tax authority server) based on the created request template. For example, a transaction identifier (e.g., a transaction identification number) may be utilized to query for a status of a request associated with the transaction. In a further embodiment, S350 may include determining the at least one data source to be queried based on the created request template. As a non-limiting example, if the request template includes a “Location of Transaction” field having a value “Germany,” the determined data source may be a server of a German tax authority. The status of the request may indicate, but is not limited to, that the request was granted, that the request was declined, that the request was not received, that the request has been received but has not yet been processed, and the like.

In an embodiment, when the status indicates that the request has been received but has not yet been processed, execution may return to S340, at which a new value for the timer may be determined and the timer may be set using the new value. The new value for the timer may be based further on an amount of time elapsed since the submission of the request. As a non-limiting example, a first value for the timer may be determined to be 21 days based on an average value for the tax reclaim agency the request was sent to. After 21 days since the submission of the request, if the status of the request indicates that the request has been received but has not been processed, a second value for the timer may be set such that the timer expires after a subsequent 9-day period (e.g., 30 days after submission of the request). In another embodiment, if a threshold amount of time has passed (e.g., 60 days since submission of the request), the status of the request may be determined to indicate that the request was declined. The threshold amount of time may be predetermined or may be determined based on, e.g., the determined value for the timer (for example, the threshold time period may be, e.g., double the determined value for the timer).

At optional S360, when it is determined that the request has not been granted, at least one cause of the lack of granting may be determined. In an embodiment, the at least one cause of the lack of granting may be determined when a status of the request indicates that the request was declined or not received. In a further embodiment, determining the cause of the lack of granting may be based on the status of the request. For example, if the status of the request indicates that the request was not received, a cause of the lack of granting may be failure to send the request to the correct entity.

In another embodiment, determining the at least one cause of the lack of granting may include comparing information of the request to information of the transaction for which the request was submitted. In a further embodiment, S360 may further include creating a transaction template for an evidencing electronic document including information related to the transaction and comparing the created transaction template to the request template. As a non-limiting example, if a name of a buyer of the transaction included in a “Buyer Name” field of a request template created based on a scanned request form does not match a name included in the corresponding field of a transaction template created based on a scanned invoice, the at least one cause of the lack of granting may be determined to include an incorrect name of the buyer. In another embodiment, S360 may include determining if one or more required request parameters is missing or otherwise incomplete based on one or more request requirements. As a non-limiting example, if there is no tax identification number in a “Tax ID” field of the request template, the at least one cause of the lack of granting may be determined to include a missing tax identification number.

In yet another embodiment, when it is determined that the request was not granted due to at least one cause included missing, incomplete, or incorrect information, additional data, replacement data, or both may be retrieved from at least one data source and included in the request template. In a further embodiment, upon retrieving the additional or replacement data, a new request may be generated and sent.

In another embodiment, S360 may further include generating at least one recommendation for correcting the at least one cause of the lack of granting. In a further embodiment, S360 may further include comparing the determined at least one cause to at least one previously determined cause of lack of granting of a request associated with a recommendation for correction.

At optional S370, a notification may be generated. The notification may indicate the status of the request. In another embodiment, when the request has not been granted, the notification may include the determined at least one cause of the lack of granting.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for automatically monitoring a request indicated in an electronic document, comprising:
analyzing the electronic document to determine at least one request parameter, wherein the electronic document includes at least partially unstructured data;
creating, based on the analysis of the electronic document, a request template for the electronic document, wherein the request template is a structured dataset including the determined at least one request parameter;
setting, based on the created request template, a timer, wherein the timer is set at least with respect to a time of submission of the request; and
upon expiration of the timer, determining, based on the created request template, a status of the request.

2. The method of claim 1, wherein determining the at least one request parameter further comprises:
identifying, in the electronic document, at least one key field and at least one value;
creating, based on the electronic document, a dataset, wherein the created dataset includes the at least one key field and the at least one value; and
analyzing the created dataset, wherein the at least one request parameter is determined based on the analysis.

3. The method of claim 2, wherein identifying the at least one key field and the at least one value further comprises:
analyzing, via optical character recognition, the electronic document to determine data in the electronic document; and
extracting, based on a predetermined list of key fields, at least a portion of the determined data, wherein the at least a portion of the determined data matches at least one key field of the predetermined list of key fields.

4. The method of claim 3, further comprising:
performing a cleaning process on the extracted at least a portion of the determined data.

5. The method of claim 1, wherein determining the status of the request further comprises:
determining, based on the created request template, at least one data source; and
querying, with respect to the request, the at least one data source to obtain the status of the request.

6. The method of claim 1, further comprising:
determining at least one cause of a lack of granting of the request, when the determined status of the request indicates that the request has not been granted.

7. The method of claim 6, wherein determining the at least one cause of the lack of granting of the request further comprises:
analyzing an evidencing electronic document to determine at least one transaction parameter, wherein the evidencing electronic document includes information of a transaction related to the request;
creating a transaction template for the evidencing electronic document, wherein the transaction template is a structured dataset including the determined at least one transaction parameter; and
comparing the created transaction template to the created request template.

8. The method of claim 6, further comprising:
retrieving, from at least one data source, at least one of additional data and replacement data; and
generating, based on the created request template and the retrieved at least one of additional data and replacement data, a new request.

9. The method of claim 1, wherein the electronic document is an image showing a request for a value-added tax reclaim, wherein the timer is set based on an expected time of processing of the request with respect to the time of submission of the request, wherein the expected time of processing represents an expected time of a change in status of the request.

10. The method of claim 9, wherein setting the timer further comprises:
querying, based on the at least one request parameter, at least one data source for an estimated time of processing for the request, wherein the timer is set further based on the estimated time of processing.

11. A non-transitory computer readable medium having stored thereon instructions for causing a processing circuitry to perform a process, the process comprising:
analyzing the electronic document to determine at least one request parameter, wherein the electronic document includes at least partially unstructured data;
creating, based on the analysis of the electronic document, a request template for the electronic document, wherein the request template is a structured dataset including the determined at least one request parameter;
setting, based on the created request template, a timer, wherein the timer is set at least with respect to a time of submission of the request; and
upon expiration of the timer, determining, based on the created request template, a status of the request.

12. A system for validating a transaction represented by an electronic document, comprising:
a processing circuitry; and
a memory, the memory containing instructions that, when executed by the processing circuitry, configure the system to:
analyze the electronic document to determine at least one request parameter, wherein the electronic document includes at least partially unstructured data;
create a request template for the electronic document, wherein the request template is a structured dataset including the determined at least one request parameter;
set, based on the created request template, a timer, wherein the timer is set at least with respect to a time of submission of the request; and
upon expiration of the timer, determine, based on the created request template, a status of the request.

13. The system of claim 12, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one request parameter is determined based on the analysis.

14. The system of claim 13, wherein the system is further configured to:
analyze, via optical character recognition, the electronic document to determine data in the electronic document; and
extract, based on a predetermined list of key fields, at least a portion of the determined data, wherein the at least a portion of the determined data matches at least one key field of the predetermined list of key fields.

15. The system of claim 14, wherein the system is further configured to:
perform a cleaning process on the extracted at least a portion of the determined data.

16. The system of claim 12, wherein the system is further configured to:
determine, based on the created request template, at least one data source; and
query, with respect to the request, the at least one data source to obtain the status of the request.

17. The system of claim 12, wherein the system is further configured to:
determine at least one cause of a lack of granting of the request, when the determined status of the request indicates that the request has not been granted.

18. The system of claim 16, wherein the system is further configured to:
analyze an evidencing electronic document to determine at least one transaction parameter, wherein the evidencing electronic document includes information of a transaction related to the request;
create a transaction template for the evidencing electronic document, wherein the transaction template is a structured dataset including the determined at least one transaction parameter; and
compare the created transaction template to the created request template.

19. The system of claim 16, wherein the system is further configured to:
retrieve, from at least one data source, at least one of additional data and replacement data; and
generate, based on the created request template and the retrieved at least one of additional data and replacement data, a new request.

20. The system of claim 12, wherein the electronic document is an image showing a request for a value-added tax reclaim, wherein the timer is set based on an expected time of processing of the request with respect to the time of submission of the request, wherein the expected time of processing represents an expected time of a change in status of the request.

21. The system of claim 20, wherein the system is further configured to:
query, based on the at least one request parameter, at least one data source for an estimated time of processing for the request, wherein the timer is set further based on the estimated time of processing
